(19) United States
(12) Patent Application Publication
(10) Pub. No.: US 2016/0189275 A1
(43) Pub. Date: Jun. 30, 2016

(54) Purchase Option Enablement for Online Tutorials

(71) Applicant: eBay Inc., San Jose, CA (US)

(72) Inventor: Lakshmanan Velusamy, Bellevue, WA (US)

(21) Appl. No.: 14/586,538

(22) Filed: Dec. 30, 2014

(51) Int. Cl. G06Q 30/06

(52) U.S. Cl. CPC G06Q 30/0633

(57) ABSTRACT

Systems and methods are disclosed to create a virtual shopping cart of products related to an online tutorial. In some embodiments, the method may include receiving an indication that a user has elected to view an online tutorial related to completing a task; determining a plurality of products that are useful for completing the task; determining a plurality of products provided by an electronic marketplace based on each of the plurality of products; determining a quantity for each of the plurality of products; and creating a virtual shopping cart having a description of each of the plurality of products, a price for each of the plurality of products, and the quantity for each of the plurality of products, the virtual shopping cart also having a button that is selectable to purchase each of the plurality of products.

### FIELD

This disclosure relates generally to purchase option enablement for on online tutorials.

### BACKGROUND

Instructional videos or online tutorials are available from a large number of websites. These instructional videos or online tutorials may include instruction from an expert in some field of endeavor that is targeted to lay persons. For example, an instructional video may instruct a person on de-boning a chicken, cooking a prime rib dinner, changing the brakes on an automobile, growing a lily, treating a flesh wound, or building a bookshelf, etc.

### BRIEF DESCRIPTION OF THE FIGURES

These and other features, aspects, and advantages of the present disclosure are better understood when the following Detailed Description is read with reference to the accompanying drawings.

FIG. 1 illustrates an example architecture in which a user may interact with an electronic marketplace and/or an online tutorial server according to some embodiments described herein.

FIG. 2 illustrates a block diagram of some components of the electronic marketplace according to some embodiments described herein.

FIG. 3 illustrates a block diagram of some components of the online tutorial server according to some embodiments described herein.

FIG. 4 is a flowchart of an example process for displaying a product list related to an online tutorial, according to at least one embodiment described herein.

FIG. 5 is a flowchart of an example process for creating a database with a product list associated with an online tutorial, according to at least one embodiment described herein

FIG. 6 illustrates a webpage according to some embodiments described herein.

### DETAILED DESCRIPTION

Systems and methods are disclosed to generate and provide a product list that may be used to complete a task that is taught in an online tutorial. An online tutorial, for example, may include an instructional video, a blog, a webpage, an audio file, a podcast, etc. The list of products, for example, may be used to create or populate a virtual shopping cart. An online tutorial may include a series of steps that may be performed in order to complete a task. In some embodiments, these tasks may require that the user is in possession of various products. For example, a cooking online tutorial may require the user to be in possession of various ingredients or kitchen tools. As another example, a do it yourself home project tutorial may require the user to be in possession of certain hardware and/or supplies. In some embodiments, one or more products may be mandatory in order for a task to be completed. In some embodiments, one or more products may be optional for the task to be completed.

For example, an online tutorial may provide instructions for de-boning a chicken, cooking a prime rib dinner, following a recipe, changing the brakes on an automobile, growing a lily, treating a flesh wound, building a bookshelf, planting a tree, building a treehouse, or assembling a go-cart, etc. Many online tutorials may require the user to have access to one or more products such as, for example, tools, ingredients, products, supplies, hardware, or materials, etc.

Embodiments described herein, may provide a product list for purchase that are related to or used in a specific online tutorial. In some embodiments, the product list may be provided as a virtual shopping cart in an electronic marketplace such that, for example, the user may purchase all or a subset of the products provided in the list of products. Moreover, the user may have the ability to change the quantities of the various products listed in the virtual shopping cart.

For example, a cooking online tutorial may require the user to be in possession of various ingredients and/or tools. The webpage that provides the online tutorial, for example, may include a link to a virtual shopping cart that includes a plurality of ingredients and/or tools. The user may then purchase all or a portion of the ingredients and/or tools in the virtual shopping cart.

As another example, a do it yourself home project may require the user to be in possession of certain hardware, tools, and/or supplies. The webpage that provides the online tutorial, for example, may include a link to a virtual shopping cart that includes the hardware, tools, and/or supplies. The user may then purchase all or a portion of the products provided in the virtual shopping cart. The virtual shopping cart may include a multiplier that may be selected by the user to indicate the number of times they plan to repeat or duplicate the task in the online tutorial.

For example, a user may elect to view a tutorial for cooking a chicken recipe for two individuals. To follow the tutorial the user may need 1 tablespoon of olive oil, 2 chicken breasts, 100 milliliters of barbeque sauce, salt, and pepper. A shopping cart may be created for this tutorial that includes the following products: 100 milliliter bottle of olive oil, 2 chicken breasts, 100 milliliter bottle of barbeque sauce, salt, and pepper. Some of the products may be listed as optional, such as, for example, the salt and the pepper. A multiplier (e.g., a widget on a webpage) may be provided that allows the user to elect to prepare the dinner for four individuals. In response, the shopping cart may automatically change the shopping cart to include the following products: 100 milliliter bottle of olive oil, 4 chicken breasts, 200 milliliter bottle of barbeque sauce, salt, and pepper. The olive oil, for example, is not changed since the 100 milliliter bottle is sufficient for doubling the recipe.

In some embodiments, the user may also elect to view a tutorial for cooking green beans with mushrooms. The recipe for two may include 1 lb. green beans, ½ pound mushrooms, 1 tablespoon olive oil, salt, and pepper. The shopping cart may then include 1 lb. green beans and ½ pound mushrooms. The olive oil, salt and pepper will not be added since they were previously added. If the user elects to cook either or both recipes for more than two individuals such that more than 100 milliliters of olive oil is required, then the shopping can be populated with two bottles of 100 milliliters of olive oil or a 200 milliliter bottle of olive oil or the like.

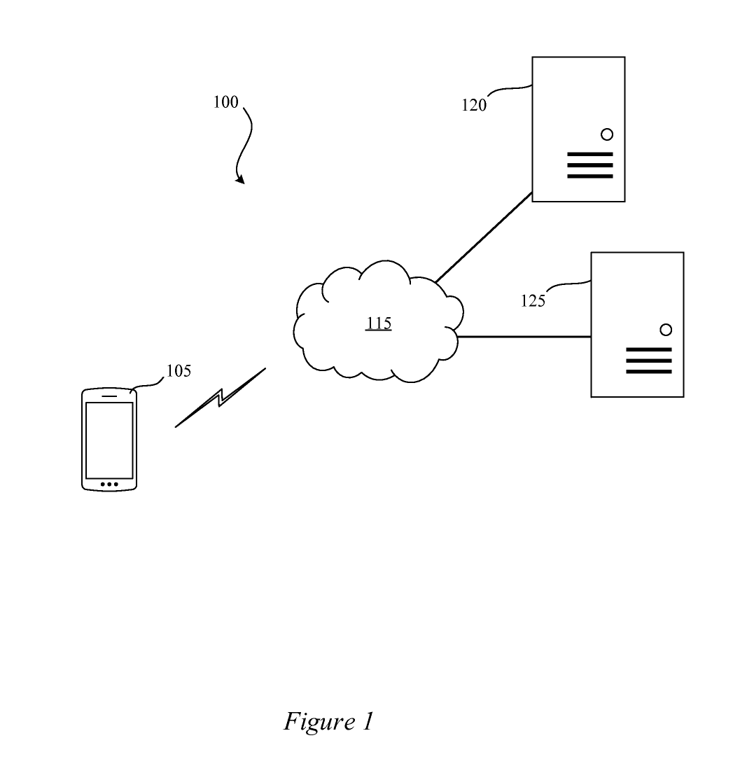

FIG. 1 illustrates an example architecture 100 in which a user may interact with an electronic marketplace and/or an online tutorial server according to some embodiments described herein. The user device 105, for example, may include a smart phone, a tablet, a computer, a desktop computer, a smart watch, or some combination thereof. The user device 105 may be communicatively connected with an electronic marketplace 120 and/or an online tutorial server 125 via network 115 either through a wired or wireless connection.

The user device 105 may include any type of mobile device such as, for example, a smart-phone, a tablet, or a smart watch, etc. In some embodiments, the user device 105 may also include, for example, a laptop computer or a desktop computer. The user device 105 may include any device that may communicate electronically with the electronic marketplace 120 and/or the online tutorial server 125 via the network 115.

The electronic marketplace 120 may host one or more websites that allow users to buy and/or sell products. The electronic marketplace 120 may include any configuration of hardware, such as servers and databases configured to provide an on-line marketplace for sellers to sell goods to buyers. For example, the electronic marketplace 120 may be configured to provide a number of publishing, listing, and price-setting mechanisms whereby a seller may list (or publish information concerning) goods or services for sale, a buyer can express interest in or indicate a desire o purchase such goods or services, and a price can be set for a transaction pertaining to the goods or services. The prices set for a transaction may be auction-format listing and price setting mechanisms (e.g., English, Dutch, Chinese, Double, or Reverse auctions, etc.). Other types of price listing formats may also be used. For example, a fixed-price listing format (e.g., the traditional classified advertisement-type listing or a catalogue listing) or a buyout-type listing format may be used. In these and other embodiments, a buyout-type listing may be offered in conjunction with auction-format listings and allow a buyer to purchase goods or services, which are also being offered for sale via an auction, for a fixed price that is typically higher than a starting price of an auction for a product. The electronic marketplace 120 may be hosted on one or more servers distributed locally or across the network 115.

The online tutorial server 125 may host one or more instructional videos, blogs, tutorials, recipes, etc. The online tutorial server 125 may include any configuration of hardware, such as servers and databases configured to provide online tutorials of various types such as, for example, instructional cooking tutorials, instructional home-improvement tutorials, instructional car repair tutorials, instructional craft tutorials, instructional fashion design tutorials, instructional art tutorials, or instructional hairdressing tutorials, etc. The online tutorial server 125 may be hosted on one or more servers distributed locally or across the network 115.

The network 115 may be any network or configuration of networks configured to send and receive communications between devices. In some embodiments, the network 115 may include a conventional type network, a wired or wireless network, and may have numerous different configurations. Furthermore, the network 115 may include a local area network (LAN), a wide area network (WAN) (e.g., the Internet), or other interconnected data paths across which multiple devices and/or entities may communicate. In some implementations, the network 115 may include a peer-to-peer network. The network 115 may also be coupled to or may include portions of a telecommunications network for sending data in a variety of different communication protocols. In some implementations, the network 115 includes Bluetooth® communication networks or a cellular communications network for sending and receiving communications and/or data including via short message service (SMS), multimedia messaging service (MMS), hypertext transfer protocol (HTTP), direct data connection, wireless application protocol (WAP), or e-mail, etc. The network 115 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 115 may include one or more IEEE 802.11 wireless networks.

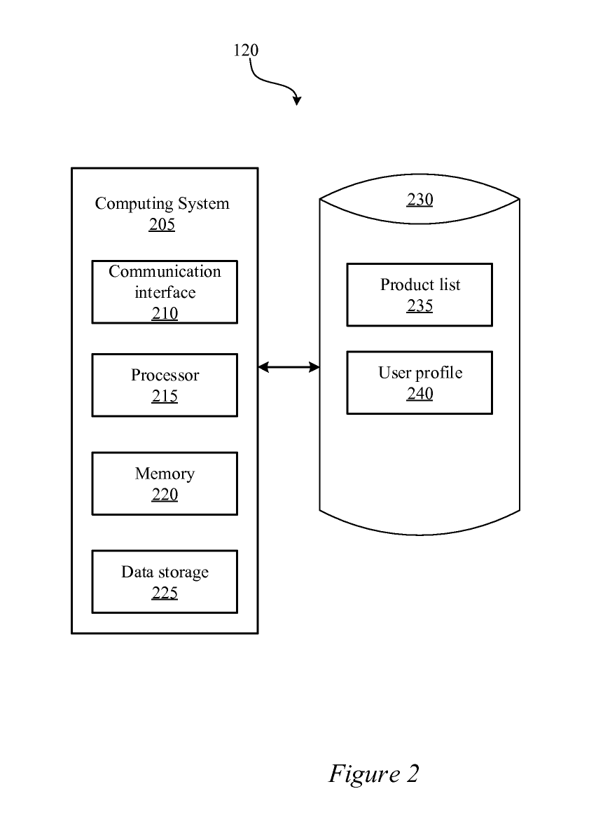

FIG. 2 illustrates a block diagram of some components of the electronic marketplace 120 according to some embodiments described herein. The electronic marketplace 120 may be arranged in accordance with at least one embodiment described herein. The electronic marketplace 120 may include computing system 205 and database 230. The computing system 205 may include a communication interface 210, a processor 215, a memory 220, and data storage 225. The processor 215, the memory 220, and the data storage 225 may be communicatively coupled.

In some embodiments, the communication interface 210 may be used by the computing system 205 to communicate with the network 115, the online tutorial server 125, and/or the user device 105. In some embodiments, the communication interface 210 may communicate with the network 115, the online tutorial server 125, and/or the user device 105 using any communication protocol, interface, standard, etc. In some embodiments, the communication interface 210 may communicate with the network 115, the online tutorial server 125 and/or the user device 105 using a wired or wireless connection.

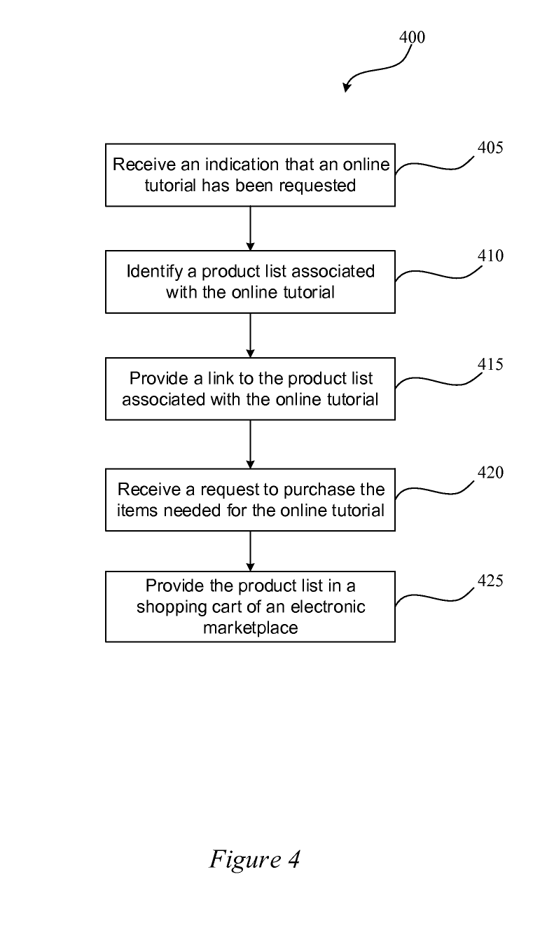

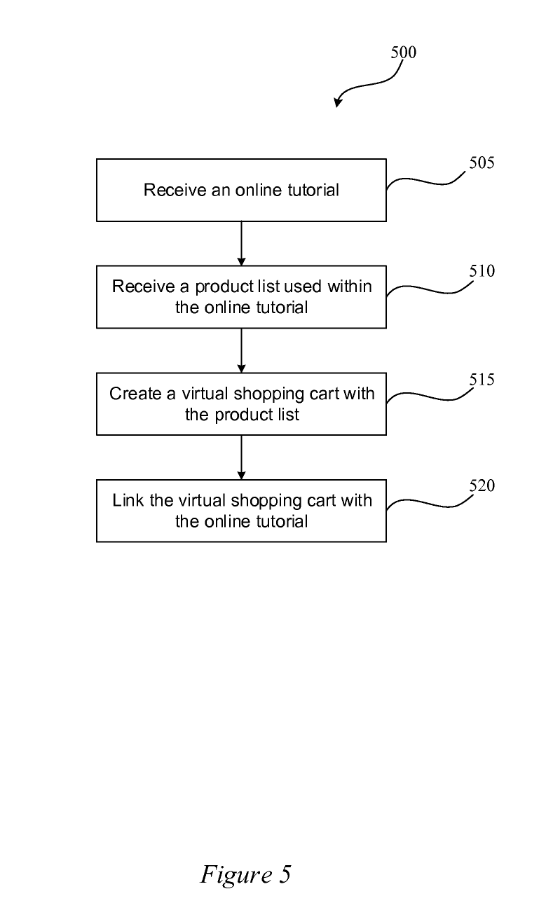

In some embodiments, the processor 215 may include any suitable special-purpose or general-purpose computer, computing entity, or processing device including various computer hardware or software modules and may be configured to execute instructions stored on any applicable computer-readable storage media. In some embodiments, the processor may execute various functions, processes or algorithms such as, for example, all or part of the processes described in FIG. 4 and/or FIG. 5. For example, the processor 215 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, it is understood that the processor 215 may include any number of processors configured to perform individually or collectively any number of operations described herein. Additionally, one or more of the processors may be present on one or more different electronic devices, such as different servers. In some embodiments, the processor 215 may interpret and/or execute program instructions and/or process data stored in the memory 220, the data storage 225, or the memory 220 and the data storage 225. In some embodiments, the processor 215 may fetch program instructions from the data storage 225 and/or the database 230 and load the program instructions in the memory 220. After the program instructions are loaded into the memory 220, the processor 215 may execute the program instructions.

In some embodiments, the memory 220 and the data storage 225 may include computer-readable storage media for carrying or having computer-executable instructions or data structures stored thereon. Such computer-readable storage media may be any available media that may be accessed by a general-purpose or special-purpose computer, such as the processor 215. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 215 to perform a certain operation or group of operations.

In some embodiments, the database 230 may be communicatively coupled with the computing system 205. The database 230 may include various databases such as, for example, a product list database 235 and a user profile database 240. The database 230 may also include multiple modules, that, when executed by the processor 215, may cause the computing system 205 to perform operations that may provide a product list for an online tutorial.

In some embodiments the product list database 235 may include a plurality of product lists that are each associated with an online tutorial. For example, a product list may be associated with a link to an online tutorial, a unique identifier for an online tutorial, a name of an online tutorial, a network location where the online tutorial is stored, or some combination thereof.

In some embodiments, the product list may itemize one or more products that may be needed or suggested to complete a task described in the associated online tutorial. For example, for each product in the product list, the product list may include a name of a product, a product type, a unique product identifier, or a link to a product listing at an online marketplace, a link to multiple products, etc. The product list, for example, may include a recommended quantity for each product in the product list based on the online tutorial; may list some products in the product list as optional; may list multiple interchangeable versions, models, or brands of a product; a product may be listed as a multiple-use product that may be used for multiple tasks shown in the online tutorial; or some combination thereof.

In some embodiments, each product in the product list may be associated with a multiplier that allows the user to view and/or purchase additional products for multiple projects, while other products in the product list may not include a multiplier such as, for example, multiple-use products. For example, a single tool may be used to complete the task in the online tutorial over and over again without requiring a new tool for each successive use. Such a tool may be considered a multiple-use product. Some products, for example, may need to be purchased each time the task in the online tutorial is attempted.

Some products may be shipped in bulk, which may allow for the user to purchase a single product to complete multiple tasks. Thus, in some embodiments, a product may be associated with a fractional multiplier.

In some embodiments, the product list may be organized as a virtual shopping cart that may allow users to purchase one or more products in the product list.

In some embodiments, the user profile database 240 may include information related to various users of the electronic marketplace 120. This information may include, for example, demographic data, the age of the user, the location of the user, preferences, the shopping history of the user, the purchasing history of the user, the most recent items viewed by the user, the most recent items purchased by the user, the most recent items placed in the virtual shopping cart but not purchased, the preferred shipping options, credit card information, listing information, address, or telephone number, etc.

In some embodiments, the product list may include multiple products that may be interchangeably used for the task presented in the online tutorial. Preferences noted in the user profile database may be used to select one of the multiple products. For example, if the online tutorial describes the process for following a recipe to cook a meal, then the product list in the product list database 235 may include the ingredients for the recipe. One product in the product list may be olive oil and may include three options: a vegan olive oil, a high end olive oil, and a standard olive oil. If the user profile database 240 identifies the user as a vegan, then the vegan olive oil will be provided. If the user profile database 240 identifies the user as preferring high end products, then the high end olive oil will be provided.

As another example, if the online tutorial describes the process for changing the brakes on a certain automobile, then the product list in the product list database 235 may include brake pads and rotors. The product list may include brake pads for the sports model of the certain automobile, brake pads for the limited edition model of the certain automobile, and brake pads for the all-wheel drive model of the certain automobile. If the user profile database 240 identifies the user as owning the all-wheel drive model, then the brake pads for the all-wheel drive model will be provided.

In view of this disclosure, it will be appreciated that modifications, additions, or omissions may be made to the electronic marketplace 120 without departing from the scope of the present disclosure. For example, the computing system 205 and the database 230 may be communicatively coupled by a network, such as the network 115 of FIG. 1. Alternately or additionally, the electronic marketplace 120 may include multiple computing systems 205 that may operate to execute one or more of the processes described herein.

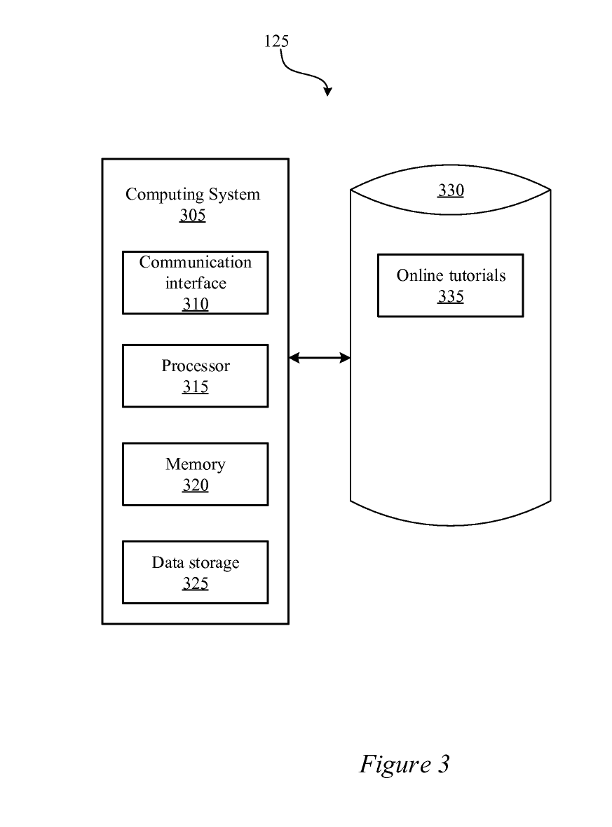

FIG. 3 illustrates a block diagram of some components of the online tutorial server 125 according to some embodiments described herein. The online tutorial server 125 may be arranged in accordance with at least one embodiment described herein. The online tutorial server 125 may include computing system 305 and database 330. The computing system 305 may include a communication interface 310, a processor 315, a memory 320, and data storage 325. The processor 315, the memory 320, and/or the data storage 325 may be communicatively coupled.

In some embodiments, the communication interface 310 may be used by the computing system 205 to communicate with the network 115, the electronic marketplace 120, and/or the user device 105. In some embodiments, the communication interface 310 may communicate with the network 115, the electronic marketplace 120, and/or the user device 105 using any communication protocol, interface, standard, etc. In some embodiments, the communication interface 310 may communicate with the network 115, the electronic marketplace 120, and/or the user device 105 using a wired or wireless connection.

In some embodiments, the processor 315 may include any suitable special-purpose or general-purpose computer, computing entity, or processing device including various computer hardware or software modules and may be configured to execute instructions stored on any applicable computer-readable storage media. In some embodiments, the processor may execute various functions, processes or algorithms such as, for example, all or part of the processes described in FIG. 4 and/or FIG. 5. For example, the processor 315 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, it is understood that the processor 315 may include any number of processors configured to perform individually or collectively any number of operations described herein. Additionally, one or more of the processors may be present on one or more different electronic devices, such as different servers. In some embodiments, the processor 315 may interpret and/or execute program instructions and/or process data stored in the memory 320, the data storage 325, or the memory 320 and the data storage 325. In some embodiments, the processor 315 may fetch program instructions from the data storage 325 and/or the database 330 and load the program instructions in the memory 320. After the program instructions are loaded into the memory 320, the processor 315 may execute the program instructions.

In some embodiments, the memory 320 and the data storage 325 may include computer-readable storage media for carrying or having computer-executable instructions or data structures stored thereon. Such computer-readable storage media may be any available media that may be accessed by a general-purpose or special-purpose computer, such as the processor 315. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 315 to perform a certain operation or group of operations.

In some embodiments, the database 330 may be communicatively coupled with the computing system 305. The database 330 may include one more databases such as, for example, an online tutorial database 335. The database 330 may also include multiple modules, that when executed by the processor 315, may cause the computing system 305 to perform operations that may provide a product list for an online tutorial.

In some embodiments, the online tutorial database 335 may include links to online tutorials stored at other locations. The online tutorial database 335 may include links to online tutorials hosted or stored at another network connected server. For example, an instructional video may be stored in a video hosting service such as, for example, at YouTube, Vimeo, Flickr, or Facebook, etc.

In view of this disclosure, it will be appreciated that modifications, additions, or omissions may be made to the online tutorial server 125 without departing from the scope of the present disclosure. For example, the computing system 305 and the database 330 may be communicatively coupled by a network, such as the network 115 of FIG. 1. Alternately or additionally, the online tutorial server 125 may include multiple computing systems 205 that may operate to execute one or more of the processes described herein.

FIG. 4 is a flowchart of an example process 400 for displaying a product list related to an online tutorial, according to at least one embodiment described herein. One or more steps of the process 400 may be implemented, in some embodiments, by one or more components of architecture 100 such as, for example, either or both the electronic marketplace 120 or the online tutorial server 125 of FIG. 1. Although illustrated as discrete blocks, various blocks may be divided into additional blocks, combined into fewer blocks, or eliminated, depending on the desired implementation.

Process 400 begins at block 405. In some embodiments, prior to block 405, a request for an online tutorial may be sent by the user of the user device 105 and may be received, for example, at the online tutorial database 335. In some embodiments, the request may be made in response to a user selecting a link to an online tutorial presented in a web browser, application, or app at the user device. The online tutorial may be stored at the online tutorial database 335. In response, the online tutorial may be provided to the user device through a webpage such as, for example, in a window in the webpage. In some embodiments, the online tutorial may be an instructional video that is streamed over the network 115 to the user device 105.

At block 405 an indication may be received at the electronic marketplace 120 that the online tutorial has been requested. For example, the online tutorial server 125 may send the indication to the electronic marketplace 120. As another example, another server or website may send the indication to the electronic marketplace 120. The indication may include a name of the online tutorial, the link to the online tutorial, a unique identifier of the online tutorial, or some combination thereof. In some embodiments, the indication may also identify the user of the user device 105 such as, for example, a user identifier, a user name, or a password, etc.

At block 410 a product list may be identified that are associated with the online tutorial. For example, the product list may be identified by looking up the online tutorial (e.g., using a name of the online tutorial, the link to the online tutorial, a unique identifier of the online tutorial, or some combination thereof) in the product list database 235. In some embodiments, a virtual shopping cart may be created based on the product list. In some embodiments, the user profile of a user may be used to select one or more of the products to include in the virtual shopping cart.

At block 415 a link to the product list may be provided to the user. For example, the link may be provided to the user as an advertisement provided as part of the online tutorial, a graphical or text advertisement provided on the same webpage as the online tutorial. The link may include a partial or complete list of the product list.

At block 420 a request to purchase the products may be received at the product list database 235 from the user device 105.

At block 425 a product list may be provided to the user device. The product list may be provided, for example, as part of a webpage, a virtual shopping cart, or some combination thereof. The product list may be provided, for example, as part of a web browser, an app, or an application executing on the user device 105. The product list may include, for example, graphical user interface elements that allow a user to increase or decrease the number of products the user wishes to purchase. The product list may include, for example, a recommended quantity for each product in the product list.

In some embodiments, the product list may include a plurality of products associated with a single given product used in the online tutorial. One of the plurality of products may be provided to the user based on user profile data stored in the user profile database 240. In other embodiments, one or more of the plurality of products may be provided to the user to allow the user to select one or more of the plurality of products.

In some embodiments, a virtual shopping cart may include information about a product that corresponds with each product in a list of products. For example, the virtual shopping cart may include the title or name for each product, an image of each product, the price of each product, the quantity of each product, or some combination thereof. As another example, the virtual shopping cart may provide shipping options for shipping the one or more of the products such as, for example, using a selectable mechanism (e.g., a drop down menu). As another example, the virtual shopping cart may also include a subtotal for the price of all of the products in the virtual shopping cart, a total shipping cost for all of the products in the shopping cart, the total purchase and shipping costs for all of the products in the virtual shopping cart or some combination thereof. As another example, the virtual shopping cart may include a field to allow a user to change the quantity of products. As another example, the virtual shopping cart may include a field to allow a user to delete a product from the virtual shopping cart.

As another example, a virtual shopping cart may additionally include a selectable “Continue Shopping” button to enable the user to shop for additional products. As another example, the virtual shopping cart may include a selectable “Proceed to Checkout” button that may enable a user to proceed to a checkout page, where the user may go through a checkout process for the products in the shopping cart. In some embodiments, the virtual shopping cart may include a button that may allow a user to replace a product in the virtual shopping cart with a different product offered by the electronic marketplace.

In some embodiments, a virtual shopping cart may include optional products. The optional products, for example, may be listed separately from the other products. As another example, the optional products may include an indication such as, for example, text specifying that the products are optional. In some embodiments, the optional products may not have a quantity listed.

In some embodiments, the product list identified in block 410 may be identified as part of a virtual shopping cart. For example, at block 410 a virtual shopping cart may be created with the products in the product list along with the quantities specified in the online tutorial. A link to this virtual shopping cart may be provided at block 415. And this virtual shopping cart may then be provided to the user at block 425.

FIG. 5 is a flowchart of an example process 500 for creating a database with a product list associated with an online tutorial, according to at least one embodiment described herein. One or more steps of the process 500 may be implemented, in some embodiments, by one or more components of architecture 100 such as, for example, either or both the electronic marketplace 120 or the online tutorial server 125 of FIG. 1. Although illustrated as discrete blocks, various blocks may be divided into additional blocks, combined into fewer blocks, or eliminated, depending on the desired implementation.

At block 505 an online tutorial may be received at either or both of the electronic marketplace 120 or the online tutorial server 125 of FIG. 1. For example, the online tutorial may be uploaded to the online tutorial server 125. As another example, a link to the online tutorial may be sent to the online tutorial server 125 or the electronic marketplace 120. In some embodiments, the electronic marketplace 120 or another computing system or server may search for online tutorials available to users. When an online tutorial is found, a link to the online tutorial may be sent and received by process 500.

At block 510, a list of products used with the online tutorial may be received at the electronic marketplace 120. In some embodiments, the list of products may include a quantity needed for each product. In some embodiments, the list of products may also indicate whether a product in the list of products is optional or required. In some embodiments, the product list may also indicate whether a product is needed for each use of the online tutorial (e.g., an ingredient) or whether a product may be used in multiple online tutorials (e.g., a tool).

In some embodiments, the online tutorial may have been received at the online tutorial server 125 at block 505 a period of time prior to receiving a list of products used within the online tutorial at block 510. For example, a user may upload an online tutorial on a specific date. Later, the user or a third party, such as, for example, a third party associated with the electronic marketplace 120, may develop and send a list of products used with the online tutorial at block 510 at a later date.

At block 515, a virtual shopping cart may be created based on the list of products and may include products provided for sale by the electronic marketplace 120. In some embodiments, the virtual shopping cart may include a web page with a list of products associated with the list of products.

In some embodiments, the list of products may specify a specific product. The virtual shopping cart may then include the specific product. For example, the list of products may specify a bag of Nestle® Toll House Semi-Sweet Morsels as a product in the list of products. The shopping cart may then include a bag of Nestle® Toll House Semi-Sweet Morsels as a product in the shopping cart.

In some embodiments, the list of products may specify a product type. For example, the list of products may specify semi-sweet chocolate chips. A specific product of semi-sweet chocolate chips that is offered for sale by the electronic marketplace may then be provided within the virtual shopping cart. If the electronic marketplace offers different types of semi-sweet chocolate chip products for sale, then a specific one of the different types of semi-sweet chocolate chip products may be provided in the virtual marketplace. The specific one may be chosen, for example, based on user reviews, price, quantity, shipping speed, availability, user profile, or some combination thereof

In some embodiments, the virtual shopping cart may include one or more products based on a product in the list of products. The one or more products may be added to the virtual shopping cart that is provided to the user based on the user profile of the user. For example, the list of products may specify semi-sweet chocolate chips. For example, a number of different products of semi-sweet chocolate chips may be included in the virtual shopping cart, which may allow the user to choose between the various products of semi-sweet chocolate chips.

As another example, a single product of semi-sweet chocolate chips may be selected based on the user profile of the user purchasing the list of products. For example, the user profile may indicate that price is important to the user, the least expensive product, therefore, may be provided. As another example, the user profile may indicate that quality is important to the user, the product with the highest reviews, therefore, may be provided to the user. As yet another example, the user profile may indicate that the user previously purchased a specific product, this previously purchased product, therefore, may be provided.

In some embodiments, the virtual shopping cart may include information about a product that corresponds with each product in the list of products. For example, the virtual shopping cart may include the title or name for each product, an image of each product, the price of each product, the quantity of each product, or some combination thereof. As another example, the virtual shopping cart may provide shipping options for shipping the one or more of the products such as, for example, using a selectable mechanism (e.g., a drop down menu). As another example, the virtual shopping cart may also include a subtotal for the price of all of the products in the virtual shopping cart, a total shipping cost for all of the products in the shopping cart, the total purchase and shipping costs for all of the products in the virtual shopping cart or some combination thereof. As another example, the virtual shopping cart may include a field to allow a user to change the quantity of products. As another example, the virtual shopping cart may include a field to allow a user to delete a product from the virtual shopping cart.

As another example, the virtual shopping cart may additionally include a selectable “Continue Shopping” button to enable the user to shop for additional items. As another example, the virtual shopping cart may include a selectable “Proceed to Checkout” button that may enable a user to proceed to a checkout page, where the user may go through a checkout process for the products in the shopping cart. In some embodiments, the virtual shopping cart may include a button that may allow a user to replace a product in the virtual shopping cart with a different product offered by the electronic marketplace.

In some embodiments, the virtual shopping cart may include optional products. The optional products, for example, may be listed separately from the other products. As another example, the optional products may include an indication such as, for example, text specifying that the products are optional. In some embodiments, the optional products may d not have a quantity listed.

In some embodiments, block 510 and block 515 may be combined. For example, rather than receiving a list of products, a virtual shopping cart may be created with a plurality of products that may be used with the online tutorial.

At block 520 a database such as, for example, the product list database 235, may link the list of products, the virtual shopping cart, the online tutorial, or some combination thereof. For example, the database may link network addresses, network locations, identifiers, names, etc., or some combination thereof together. For example, the database may be used to determine the list of products and/or the virtual shopping cart by identifying the online tutorial. The database may be used, for example, in process 500 of FIG. 5.

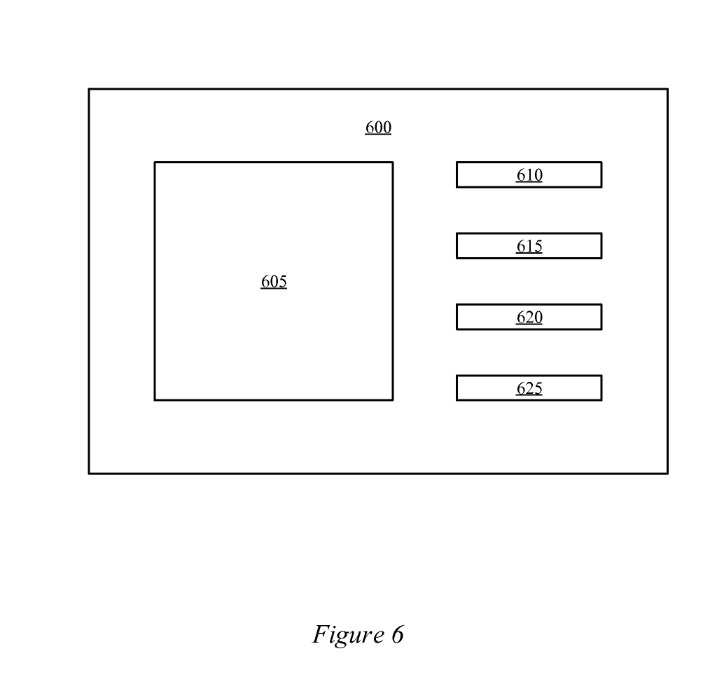

FIG. 6 illustrates a webpage 600 according to some embodiments described herein. Webpage 600 may include a video presentation window 605 and a plurality of graphics and/or links 610, 615, 620, and 625. In some embodiments, an instructional video may be provided (e.g., streamed) in video presentation window 605. In conjunction with providing the instructional video, link 610 may be selected by the user and directed to a virtual shopping cart webpage hosted by electronic marketplace 120 that includes products for the products used in the instructional video provided in presentation window 605. In some embodiments, the products may be listed with previously identified quantities. In some embodiments, link 615 may be selected by the user and directed to a virtual shopping cart webpage hosted by another different electronic marketplace (a second electronic marketplace) that includes products for the products used in the instructional video provided in presentation window 605. Links 620 and 625 may be directed to a third and fourth electronic marketplace that includes products for the products used in the instructional video provided in presentation window 605. Various other links, graphics or advertisements may be included on webpage 600.

In some embodiments, the creator of the virtual shopping cart, which may be the owner, host, author, etc. of the online tutorial, may be rewarded when user purchases products listed in the virtual shopping cart. For example, the link to the virtual shopping cart (e.g., the link provided in block 415 of process 400 of FIG. 4) may include an identifier that identifies the creator of the virtual shopping cart. The electronic marketplace may reward the creator of the virtual shopping cart with a percentage of money collected or earned when the user purchases the products in the virtual marketplace.

Some embodiments include a method comprising receiving an indication that a user has elected to view an online tutorial related to completing a task; determining a plurality of products that are useful for completing the task; determining a plurality of products provided by an electronic marketplace based on each of the plurality of products; determining a quantity for each of the plurality of products; and creating a virtual shopping cart having a description of each of the plurality of products, a price for each of the plurality of products, and the quantity for each of the plurality of products, the virtual shopping cart also having a button that is selectable to purchase each of the plurality of products.

In some embodiments, the indication may include a link to the online tutorial. In some embodiments, the determining a plurality of products that are useful for completing the task further comprises looking up the plurality of products in a database using at least a portion of the indication. In some embodiments, the virtual shopping cart includes two products for one of the plurality of products. In some embodiments, the plurality of products may comprise one or more products that are multiple use products.

In some embodiments, the method may also include providing a webpage that includes the online tutorial and a link to the virtual shopping cart. In some embodiments, the method may also include providing a link to the virtual shopping cart.

In some embodiments, a system may include storage means for storing one or more virtual shopping carts that include a plurality of products useful for completion of a task illustrated in a plurality of online tutorials that are available to be viewed online. The system may also include processing means for receiving an indication that a user has chosen to view a chosen online tutorial of the plurality of online tutorials, selecting a virtual shopping cart from the plurality of virtual shopping carts stored in the storage means that is associated with the chosen online tutorial and includes a plurality of products, and providing a link to the virtual shopping cart associated with the chosen online tutorial.

In some embodiments, the indication may include a link to the chosen online tutorial. In some embodiments, the processing means may select a virtual shopping cart from the one or more virtual shopping carts stored in the storage means based on the link to the chosen online tutorial.

In some embodiments, the processing means may determine a user profile of the user; and select one or more products of the plurality of products based on the user profile.

In some embodiments the virtual shopping cart comprises a description of each of the plurality of products, a price for each of the plurality of products, and a quantity for each of the plurality of products.

In some embodiments, the processing means may create an advertisement for the selected virtual shopping cart that includes the link to the virtual shopping cart and providing the advertisement.

In some embodiments, a method may include receiving an indication that a user has elected to view an online tutorial related to completing a task; determining a plurality of products that are useful for completing the task and a quantity for each product; and creating a virtual shopping cart webpage that lists one or more of the plurality of products with a respective quantity of the one or more of the plurality of products such that a viewer of the virtual shopping cart webpage may purchase each of the one or more of the plurality of products.

In some embodiments, the method may include determining a user profile based at least in part on the indication; and selecting one or more products of the plurality of products based on the user profile.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A method comprising:
receiving an indication that a user has elected to view an instructional video related to completing a task;
determining a plurality of products that are useful for completing the task;
determining a plurality of products provided by an electronic marketplace based on each of the plurality of products;
determining a quantity for each of the plurality of products; and
creating a virtual shopping cart having a description of each of the plurality of products, a price for each of the plurality of products, and the quantity for each of the plurality of products, the virtual shopping cart also having a button that is selectable to purchase each of the plurality of products.

2. The method according to claim 1, wherein the indication includes a link to the instructional video.

3. The method according to claim 1, wherein determining a plurality of products that are useful for completing the task further comprises looking up the plurality of products in a database using at least a portion of the indication.

4. The method according to claim 1, wherein the virtual shopping cart includes two products for one of the plurality of products.

5. The method according to claim 1, further comprising providing a webpage that includes the instructional video and a link to the virtual shopping cart.

6. The method according to claim 1, further comprising providing a link to the virtual shopping cart.

7. The method according to claim 1, wherein the plurality of products comprise one or more products that are multiple use products.

8. One or more non-transitory computer-readable media storing one or more programs that are configured, when executed, to cause one or more processors to execute the method as recited in claim 1.

9. A system comprising:
storage means for storing one or more virtual shopping carts that include a plurality of products useful for completion of a task illustrated in a plurality of online tutorials that are available to be viewed online; and
processing means for receiving an indication that a user has chosen to view a chosen online tutorial of the plurality of online tutorials, selecting a virtual shopping cart from the plurality of virtual shopping carts stored in the storage means that is associated with the chosen online tutorial and includes a plurality of products, and providing a link to the virtual shopping cart associated with the chosen online tutorial.

10. The system according to claim 9, wherein the indication includes a link to the chosen online tutorial; and wherein the processing means selects a virtual shopping cart from the one or more virtual shopping carts stored in the storage means based on the link to the chosen online tutorial.

11. The system according to claim 9, wherein the processing means are further for determining a user profile of the user; and selecting one or more products of the plurality of products based on the user profile.

12. The system according to claim 9, wherein the virtual shopping cart comprises a description of each of the plurality of products, a price for each of the plurality of products, and a quantity for each of the plurality of products.

13. The system according to claim 9, wherein the processing means are further for creating an advertisement for the selected virtual shopping cart that includes the link to the virtual shopping cart and providing the advertisement.

14. A method comprising:
receiving an indication that a user has elected to view an online tutorial related to completing a task;
determining a plurality of products that are useful for completing the task and a quantity for each product; and
creating a virtual shopping cart webpage that lists one or more of the plurality of products with a respective quantity of the one or more of the plurality of products such that a viewer of the virtual shopping cart webpage may purchase each of the one or more of the plurality of products.

15. The method according to claim 14, further comprising:
determining a user profile based at least in part on the indication; and
selecting one or more products of the plurality of products based on the user profile.

16. The method according to claim 14, wherein the indication is received from at least one of a device selected from the list consisting of a video hosting service, a user device, and a webserver.

17. One or more non-transitory computer-readable media storing one or more programs that are configured, when executed, to cause one or more processors to execute the method as recited in claim 14.

18. The method according to claim 14, wherein the indication includes a link to the online tutorial, and wherein the determining a plurality of products useful for completing the task further comprises looking up the plurality of products in a database based on the link to the online tutorial.

19. The method according to claim 14, wherein the indication comprises at least one of an online tutorial name, an online tutorial identifier, and a link to the online tutorial.

20. The method according to claim 14, further comprising providing a link to the virtual shopping cart webpage.
